(19) United States
(12) Patent Application Publication
(10) Pub. No.: US 2020/0017015 A1
(43) Pub. Date: Jan. 16, 2020

(54) Lifting Device with Ropes for Beds in Recreational Vehicles

(71) Applicant: ST.LA. S.R.L., PONTEDERA (IT)

(72) Inventor: STEFANO ZAPPOLINI, PONTEDERA (IT)

(21) Appl. No.: 16/470,824

(22) PCT Filed: Dec. 19, 2017
(86) PCT No.: PCT/IB17/58146

§ 371 Date: Jun. 18, 2019

(30) Foreign Application Priority Data
Dec. 19, 2016 (IT) 102016000127978

(51) Int. Cl. B60P 3/39; B60N 3/00

(52) U.S. Cl. CPC B60P 3/39; B60N 3/008

(57) ABSTRACT

The device (1) activates a lifting mechanism (2) with ropes (21, 22, 23, 24) of a suspended bed (3), with the same ropes (21, 22, 23, 24) deflected below the supporting frame (20) of the bed (3) and fixed to a common draw hook (26), moved by the device (1), in which are provided: a pulley (4), rotatable horizontally under the supporting frame (20); a cogwheel (40), integral with the pulley (4); a gas spring (5), with a rack (50) engaged with said cogwheel (40) to operate it in rotation; a flexible cable (6), secured with one end to the pulley (4) and partially wound on the latter, and secured with the remaining end to the draw hook (26). The lifting of the bed (3) takes place with the rotation of the pulley (4) pushed by the gas spring (5), whereby the flexible cable (6) pulls the draw hook (26) causing the dragging of the ropes (21, 22, 23, 24); in the lowering, vice versa, the ropes (21, 22, 23, 24) drag in the opposite direction the draw hook (26) which, in turn, pulls the flexible cable (6), thus rotating the pulley (4) in the opposite direction and reloading the gas spring (5).

### TECHNICAL FIELD

The present invention relates to the technical field inherent to furniture for caravans, campers, motor homes, cabin boats and the like, with particular reference to the foldaway beds.

### STATE OF THE ART

For these types of vehicles and boats, the primary requirement is to make the most, in the most rational way, of the available spaces which by their nature are limited when not small.

One of the most used systems for optimizing spaces is the hinged articulation of the furnishing elements, so as to be able to rotate them, or overturn them in order to dispose them in conditions of use or rest, depending on the case.

The system just mentioned is also applied to beds, for example in many truck cabins.

Another constructive method used for some types of beds requires that they are suspended, so that they can be lowered when needed and lifted when not needed, so as to move their encumbrance to a position where they disturb less.

To move said suspended beds, it is known a rope system which requires four of said suspension cables, or belts, which are arranged substantially at the corners of the bed; each rope has an upper end hanging from a fixed support, for example the roof of the cabin, from which a substantially vertical branch extends ending where the rope engages under a return pulley provided in the bed, from which it is then deflected below the latter, substantially horizontally.

All the ropes, therefore, belong to a device, housed under the same bed and shaped as much as possible flattened, designed to pull, collect and hold an equal length of each rope during the lifting and, vice versa, to release equal amount during the lowering of the bed.

Various types of such devices are known, many of which are also provided with measures to aid the lifting phase and to brake the lowering phase, counteracting the gravity.

In the Document EP2987429 it is protected a device comprising a slide to which the four ropes each coming from a corner of the bed support platform, suitably deflected by return rollers so that all of them are horizontal and oriented and that the direction of pull and release is concordant.

The slide is slidable along a rectilinear guide, by the action of a linear actuator, arranged parallel to said guide and capable of imparting to the same slide a first stroke in which the four ropes are simultaneously pulled, determining the lifting of the bed.

During the lowering of the bed, the ropes tend to drag the slide in the opposite direction, for a second run inverse to the first, with consequent opposite movement of the linear actuator.

In the preferred described and illustrated embodiment, the linear actuator is constituted by a gas spring, whose active extension stroke is accomplished during the lifting of the bed.

During the lowering of the bed, favored by the gravity, the ropes drag the slide in the opposite direction, causing a compression phase of the gas spring, which will be recharged for a new bed lifting once the lowering is complete.

The linear actuator, according to a variant of the claimed embodiment, is of motorized type.

The device described and protected in the document mentioned above requires a unitary relationship between the stroke of the actuator, that of the slide and the length of the pulled or released ropes stretches, so that necessarily even the amplitude of the ascent and descent movement of the bed has the same value.

This represents a functional drawback, given by the fact that the kinematism, as proposed, has a maximum limit for the ascent and descent excursion fixed, in an impassable way, by the maximum length of the device allowed by the dimensions of the support platform.

The same characteristic also proves to be a structural disadvantage, since it requires a very long linear actuator which, if constituted by a gas spring, can be not very effective and/or subject to anomalous bending of the stem, or rather expensive if it consists of a linear motor.

Moreover, the device does not allow any calibration maneuver that allows to modify the balances, and therefore the response, for example to adapt it to variations in the total weight of the bed, due to different mattresses or blankets or other.

### SUMMARY OF THE INVENTION

Object of the present invention is therefore to propose a device for operating a lifting system of a suspended bed which is shaped so as to be at the same time compact, reliable in operation and able to overcome the drawbacks of known devices and, in particular, of that referred to in said document.

Another object of the invention is to provide a device in which it is possible to obtain a considerable vertical excursion of the bed, without this leading to constructive complications.

A further object of the invention is to provide the device with locking means to stabilize at least the maximum lifting position.

Yet another object of the invention is to obtain a simple and low-cost device.

These and other objects are fully achieved by means of a device for operating a lifting system for a suspended bed, with such a system comprising a supporting frame to said bed, of rectangular shape, and at least four ropes, each of which fixed in suspension to a fixed structure at the top, extended downwards till the vicinity of a corresponding corner of said supporting frame, then to sequentially engage returning rollers, provided in the latter to deflect the same rope according to a predetermined path which terminates with a horizontal section, arranged below said supporting frame and parallel to the corresponding horizontal sections of the remaining ropes, with all ends of these fixed to a common draw hook, which is provided to be moved in parallel to the same ropes, with said device comprising:
at least one pulley (4), rotatably carried by said supporting frame (20), with substantially vertical rotation axis;
a cogwheel (40), made coaxially integral to said pulley (4), on the side of this;
a linear drive element (5), integral with a first end of its own with said supporting frame (20) and having associated, at the second end of its own, a rack (50), extended parallel to the element (5) itself and intended to engage with said cogwheel (40) in order to rotate it together with said pulley (4);
a flexible cable (6), fixed with one end to said pulley (4) and wound on the latter with an intermediate portion of its own, engaged with at least one returning roller (60) arranged downstream of the latter and secured with the remaining end to said draw hook (26) of the ropes (21, 22, 23, 24), so that to the rotation of the pulley (4) and of the cogwheel (40) corresponds an activation of the same flexible cable (6) for imparting/enabling to said draw hook (26) rectilinear excursions, respectively in a first direction, in which the same hook (26) and the ropes (21, 22, 23, 24) are urged into shot to lift said bed (3), and in an opposite direction, in phase relation with the lowering of the same bed (3), in which to the hook (26) and to the ropes (21, 22, 23, 24) is permitted a return stroke.

### BRIEF DESCRIPTION OF THE DRAWINGS

The characteristics of the invention will be clear from the following description of a preferred embodiment of the device for operating a lifting system of a suspended bed in question, in accordance with what is proposed in the claims and with the aid of the attached drawings, in which:

FIG. 1 shows a schematic side view of a suspended bed with a rope system;

FIG. 2 shows an axonometric view from below of the bed of FIG. 1, in which the device in question is visible;

FIG. 3 shows a partial view, from below, of the bed of FIG. 2, with the device in the position corresponding to the lifted bed;

FIG. 4 shows a view similar to FIG. 3, with the device in the position corresponding to the lowered bed;

FIGS. 5 and 6 show views similar to FIGS. 3 and 4, relating to a second embodiment of the device;

FIG. 7 illustrates a further embodiment of the device of the invention.

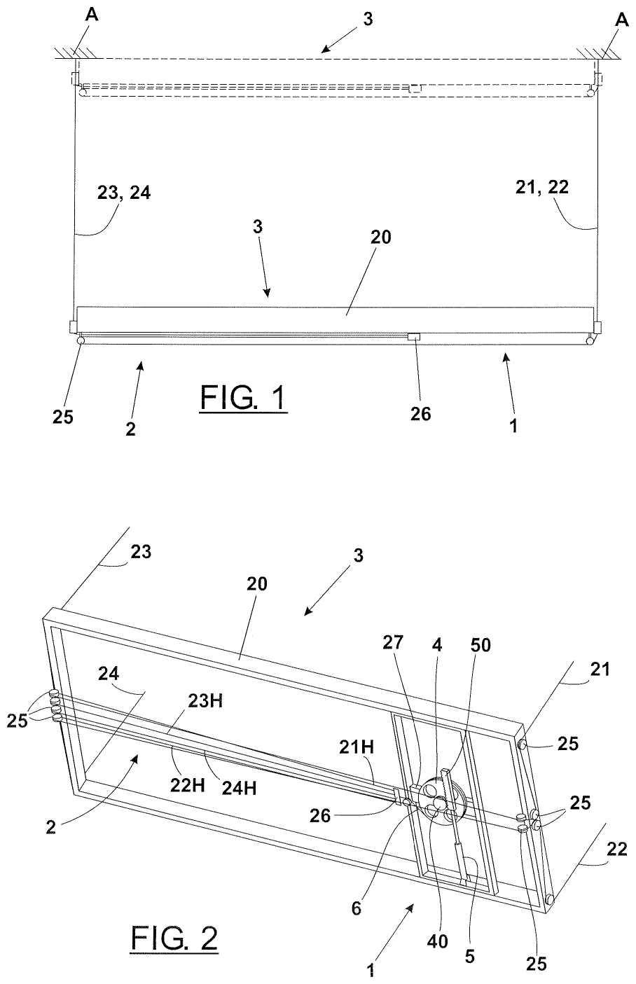

### DESCRIPTION OF THE PREFERRED EMBODIMENTS

In the above-mentioned figures, the device object of the present invention has been indicated as a whole with reference 1.

The device 1 is adapted to operate a lifting mechanism 2 of a suspended bed 3, for example of the type mentioned in the introduction, provided in caravans, campers, motor homes, cabin boats and the like.

In a self-known manner, the lifting mechanism 2 comprises a supporting frame 20 for said bed 3, of rectangular shape, and at least four ropes 21, 22, 23, 24, each of them fixed in suspension to a fixed structure A at the top, consisting for example of the cabin roof of one of said vehicles.

Each rope 21, 22, 23, 24 is extended downwards close to a corresponding corner of said supporting frame 20, to then sequentially engages returning rollers 25, provided in the latter with suitable positions and orientations, for deviating the same rope according to a predetermined path that ends with a horizontal portion 21H, 22H, 23H, 24H, arranged beneath said supporting frame 20 and almost parallel to the corresponding horizontal portions 21H, 22H, 23H, 24H of the remaining ropes.

All the ends of the horizontal portions 21H, 22H, 23H, 24H are fixed to a common draw hook 26, which is provided to be moved parallel to the same ropes 21, 22, 23, 24 by the device 1.

The latter, according to the invention, comprises at least one pulley 4, which can be rotated by a cross-member 27 of the supporting frame 20, with substantially vertical rotation axis.

The pulley 4 coaxially supports, on one side, a cogwheel 40, of a suitably inferior diameter.

A linear drive element 5 is made integral, with an end of its own, to the supporting frame 20 and having associated with the other end of its own, motion transformation means which transform said translation into a synchronous rotation of said cogwheel (40) and pulley (4). More specifically, in the embodiment of FIGS. 2, 3 and 4 the motion transformation means are constituted by a rack 50, extended parallel to the element 5 itself and intended to gear with said cogwheel 40 to rotate it together with said pulley 4.

The device 1 further comprises a flexible cable 6, fixed with one end to said pulley 4 and wound on the latter with an intermediate portion of its own, for then engaging at least one returning roller 60 arranged downstream of the latter and being fixed, with the remaining end, to said draw hook 26 of the ropes 21, 22, 23, 24.

On the rotation of the pulley 4, therefore, there is a winding or unwinding of the flexible cable 6 on or from it, to which corresponds an actuation of the same flexible cable 6 for impressing/allowing to said draw hook 26 rectilinear excursions, respectively in a first direction T, in which the same hook 26 and the ropes 21, 22, 23, 24 are urged into shot to lift said bed 3, and in an opposite direction R, in phase relation with the lowering of the same bed 3, wherein to the hook 26 and to the ropes 21, 22, 23, 24 a return stroke is allowed.

In the embodiment shown in FIGS. 2, 3, 4, said linear drive element 5 is constituted by a gas spring, whose push action is directed to impart a translation of said rack 50 and, consequently, a synchronous rotation of said cogwheel 40 and pulley 4 according to a direction concordant with the lifting action of the bed 3, as further specified below.

Specularly, the rotation of the pulley 4 in the direction in which the bed 3 falls, causes a translation in the opposite direction of the rack 50, with the complete re-entry of the stem 50 of the gas spring 5.

As can be easily understood, by varying the ratio between the diameter of the pulley 4 and that of the cogwheel 40, a greater or smaller linear excursion of the flexible cable 6 is obtained, at the same run of the rack 50.

In said embodiment, it is advantageously envisaged to associate to the linear drive element 5 locking means, suitable for stabilizing at least the raised position of said bed 3.

Said locking means are of substantially known type and therefore are not shown in detail; by way of example, they can be constituted by a pin, or a pawl, which snaps into position by engaging a hole or a tooth in the pulley 4 or in the rack 50, upon reaching said raised position of said bed 3.

The release is made by a manual control (also not shown) brought to the side of the bed 3 by a suitable linkage.

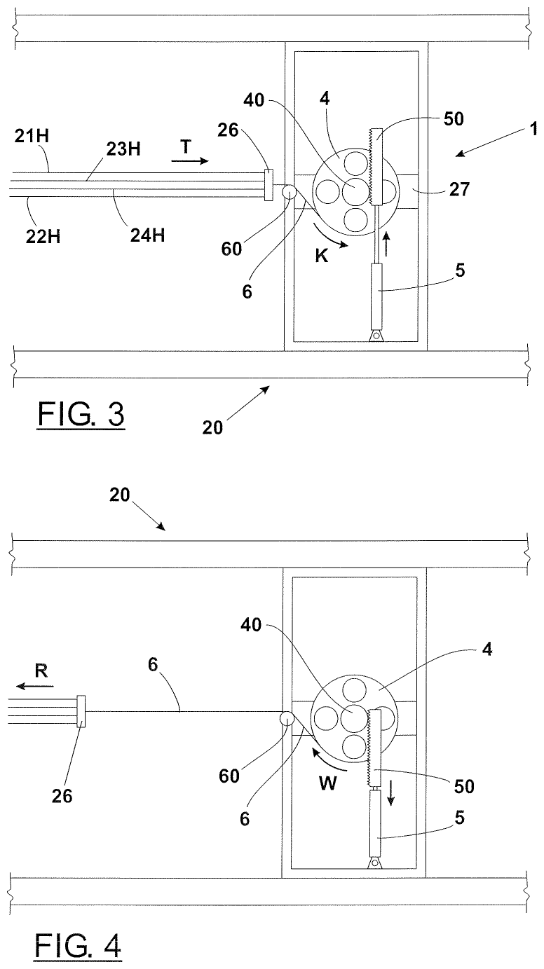

The operation of the device 1 thus produced, however already partially anticipated by the description above, provides that the raising of the bed 3 is at least facilitated by the pushing action of the gas spring 5, which acting on the pulley 4 through the rack 50 and the cogwheel 40 makes it rotate in a first direction K, in which the flexible cable 6 pulls the draw hook 26 (arrow T in FIG. 3), determining for it a rectilinear excursion proportional to the development of the winding circumference on the pulley 4 and, consequently, equal pull stresses on the ropes 21, 22, 23, 24.

The lowering of the bed 3, vice versa, is at least partly determined by the gravity, so that the ropes 21, 22, 23, 24 drag in the opposite direction the draw hook 26 (arrow R in FIG. 4) which, in turn, pull the flexible cable 6; the pulley 4 is therefore driven to rotate in the opposite direction W, causing the return of the stem 50 of the gas spring 5, which is thus recharged.

As a constructive variant, it is expected that the linear drive element 5 is constituted by a motorized actuator; the operation of the device 1 remains substantially unchanged regarding the movement of the pulley 4, of the flexible cable 6, of the draw hook 26 and of the ropes 21, 22, 23, 24, except for the fact that the ascent and descent movements of the bed 3 become fully automatic and do not require any manual intervention or “help”.

For this variant, the presence of said locking means may not be necessary, since the motorized actuator could advantageously be of the self-braking type.

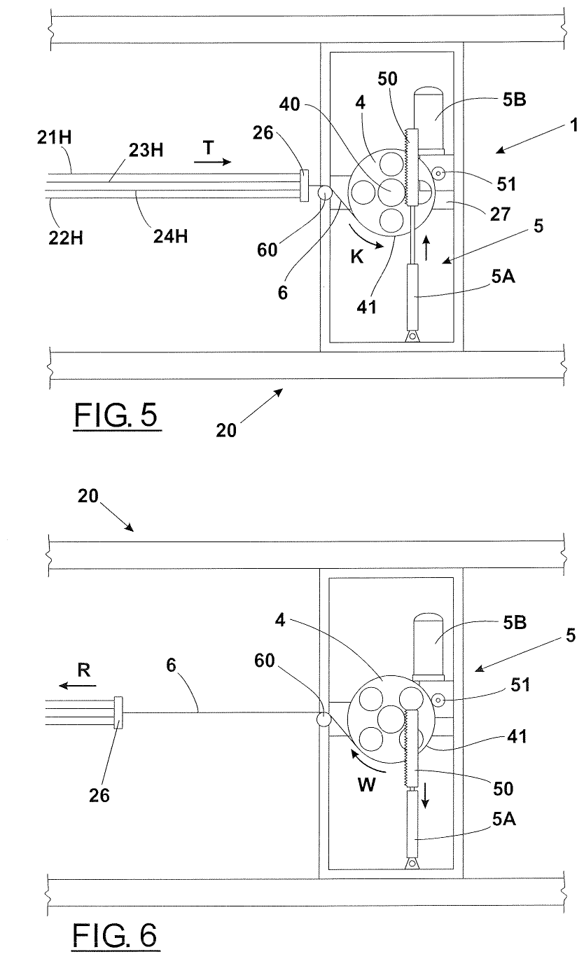

In an interesting second embodiment of the device 1, shown in FIGS. 5 and 6, said linear drive element 5 comprises a gas spring 5A, associated with the rack 50 for determining the rotation with same direction of said cogwheel 40 and pulley 4, similarly to what previously described. Furthermore, a ring gear 41 is integral with (or realized into) the outer circumference of said pulley 4, and it is present a geared motor 5B, on whose output shaft is keyed a pinion 51 engaged with the ring gear 41.

The geared motor 5B is adapted to cooperate with said gas spring 5A to determine the rotation in the two directions K, W of the pulley 4, then the ascent and descent of the bed 3

With this constructive solution, the locking means are in fact incorporated into the drive members, for example if the gear unit is of the endless screw and helical wheel type therefore, as is known, irreversible in the motion direction.

Every position of the bed 3 reached, of ascent and descent, even partial, is automatically stabilized.

The interaction between the push of the gas spring 5A and the power of the geared motor 5B can be combined in various ways to make one or the other prevail, nevertheless exploiting the characteristic of said gear unit.

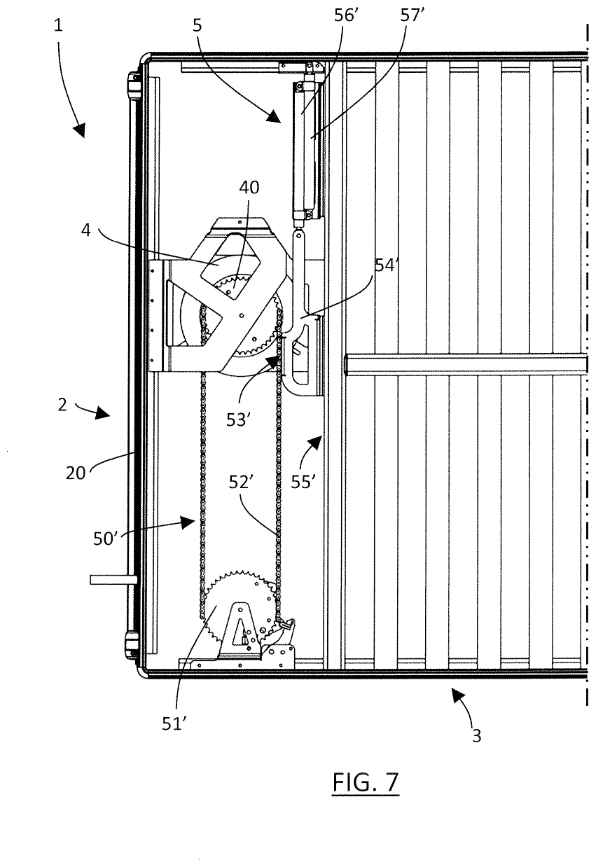

A further embodiment is shown in FIG. 7 in which it is shown a frame complete with a bed 3, but in which, for representation simplicity, it is not shown the system of ropes and return pulleys that are part of the lifting mechanism 2, but which, also in this embodiment, are arranged in a way functionally similar to the one shown in the previous figures. In the present embodiment, the linear drive element 5 comprises two gas springs, 56′, 57′, arranged parallel one next to the other, connected in succession one to the other and in which one of them is integral with the frame 20 supporting the bed while the other is integral with the motion transformation means, so as to double the useful stroke of the linear drive element 5 with the same minimum encumbrance in the drive direction.

In this embodiment the motion transformation means consist of a second cogwheel 51′, substantially coplanar to the cogwheel 40 and having axis rotatably integral with said supporting frame 20 and of a transmission chain, 50′, closed in a loop between the cogwheel 40 and the second cogwheel 51′. The second end of the linear drive element 5 is made integral with chain links, 53′, of said transmission chain 50′, so that the actuation of the linear drive element 5 moves the chain links 53′ along the closed path of the transmission chain 50′ causing the cogwheel 40 to rotate and thereby causing the bed 3 to be lifted or lowered. More specifically, the second cogwheel 51′ is arranged such that at least a linear portion, 52′, of the transmission chain 50′ runs parallel to the actuation direction of the linear drive element 5. The motion transformation means further comprises a skid, 54′, driven to move in a guide rail, 55′, integral with the frame 20 and arranged according to the direction of the linear portion 52′. The skid 54′ is integral with the second end of the linear drive element 5 as well as with chain links 53′ of said linear portion 52′. Thanks to said construction, the actuation of the linear drive element 5 moves the skid 54′ along the guide rail 55′, thus bringing the transmission chain 50′ into motion which in turn drives the cogwheel 40 in rotation.

This last embodiment is particularly solid and reliable over time thanks to the possibility of making solid and secure couplings between the various motion transmission components.

From the above description the peculiar characteristics of the proposed device are clearly clear, in particular regarding its compactness in relation to the width of the vertical excursion allowed to the bed; this advantageous aspect is increasingly evident in comparison with the prior art referred to in the document cited in the introduction.

The vertical excursion possible for the bed can become very wide, thanks to the amplification effect given by a large diameter pulley, which can be easily adopted without particular complications.

The technical solution that provides the geared motor in combination with the gas spring is particularly advantageous.

For all the embodiments described, it is easy to introduce, if not already inherent in the constructive solution itself, means for stabilizing the positions reached by the bed, in order to avoid at least undesirable lowerings, potentially dangerous.

Furthermore, it is evident how the characteristics of an embodiment can be combined and integrated into a different embodiment.

It is also evident that the constructive solutions described are extremely simple, guaranteeing a low production cost.

It is understood however that what above said has exampling and not limiting value, therefore any modifications of detail that may be necessary to be made for technical and/or functional reasons, are considered from now on as remaining within the same protective scope defined by the claims below.

1.-10. (canceled)

11. A device for driving a suspended bed lifting mechanism, wherein the mechanism includes a supporting frame to the bed, is of rectangular shape, and has at least four ropes, each of which is secured at its top to a fixed structure, extended downward until a corresponding edge of the supporting frame, then to sequentially engage returning rollers, provided in the latter to deflect the four ropes according to a predetermined path which ends with a horizontal portion, displaced below the supporting frame and almost parallel to the corresponding horizontal portions of the four ropes, with all the respective ends of the four ropes bound to a common draw hook, which is provided to be moved together with the four ropes, comprising:
at least one pulley, rotatably carried by the supporting frame, with a substantially vertical rotation axis;
a first cogwheel, made coaxially integral to the pulley;
a linear drive element, integral with one of its ends with the supporting frame and having associated, at the other end thereof, motion transformation means; and
a flexible cable, bound at one end to the pulley and wound about the latter with an intermediate portion thereof engaged with at least one returning roller arranged downstream and secured with an end to the draw hook of the four ropes, so that to the rotation of the pulley and of the first cogwheel corresponds a driving of the flexible cable for imparting or enabling to the draw hook rectilinear movements, respectively in a first direction, in which the hook and the four ropes are pulled to lift the bed, and in an opposite direction, in phase relation with the descent of the bed, in which to the hook and to the four ropes is permitted a return stroke.

12. The device according to claim 11, wherein the linear drive element is a linear actuator.

13. The device according to the claim 11, wherein the linear drive element comprises at least one gas spring, which push action is directed to impart a translational motion to the motion transformation means that transforms the translational motion into a synchronous rotation of the first cogwheel and pulley in a direction concordant with the action of lifting the bed.

14. The device according to claim 13, wherein the linear drive element comprises two gas springs arranged parallel to each other, connected in succession to each other and in which one of them is integral to the supporting frame while the other is integral with the motion transformation means, so as to double the useful stroke of the linear drive element with minimum encumbrance in the drive direction.

15. The device according to claim 13, further comprising locking means associated with the linear drive element and provided to stabilize at least the raised position of the bed.

16. The device according to claim 11, wherein the motion transformation means includes a second cogwheel substantially coplanar to the first cogwheel and having an axis rotatably integral with the supporting frame and of a transmission chain closed in a loop between the second cogwheel and the first cogwheel, the second end of the linear drive element being made integral with chain links of the transmission chain, so that the actuation of the linear drive element moves the chain links along the closed path of the transmission chain bringing the first cogwheel into rotation.

17. The device according to claim 16, wherein the second cogwheel is arranged in such a way that at least one linear portion of the transmission chain runs parallel to the motion direction of the linear drive element, wherein the motion transformation means includes a skid, guided to move in a guide rail according to the direction of the linear portion, the skid being integral with the second end of the linear drive element and with chain links of the linear portion.

18. The device according to claim 11, wherein the motion transformation means includes a rack, extended parallel to the element itself and operable to engage with the first cogwheel in order to rotate it together with the pulley.

19. The device according to claim 18, wherein the linear drive element comprises:
a gas spring, associated to the rack to determine the rotation with the direction of the first cogwheel and pulley;
a ring gear integral with the outer circumference of the pulley; and
a geared motor, on whose output shaft is keyed a pinion meshed with the ring gear, with the geared motor arranged to cooperate with the gas spring to determine the rotation in the two directions of the pulley, then the ascent and descent of the bed and to stabilize at least the raised position of the latter.

20. The device according to claim 11, wherein the first cogwheel has a diameter lower than that of the pulley.
